(19) United States
(12) Patent Application Publication
(10) Pub. No.: US 2024/0346399 A1
(43) Pub. Date: Oct. 17, 2024

(54) RESOURCE SCHEDULING METHOD AND SYSTEM

(71) Applicants: COSMO INSTITUTE OF INDUSTRIAL INTELLIGENCE (QINGDAO) CO., LTD., Qingdao (CN); COSMO DIGITAL TECHNOLOGY (QINGDAO) CO., LTD., Qingdao (CN); COSMO IOT TECHNOLOGY CO., LTD., Qingdao (CN)

(72) Inventors: Lucheng CHEN, Shandong (CN); Xiaoyi YU, Shandong (CN); Ming SUN, Shandong (CN); Xiaoping LU, Shandong (CN); Weifeng LIU, Shandong (CN); Yumei WANG, Shandong (CN); Yaqiong GAO, Shandong (CN)

(21) Appl. No.: 18/757,380

(22) Filed: Jun. 27, 2024

Related U.S. Application Data
(63) Continuation of application No. PCT/CN2022/140107, filed on Dec. 19, 2022.

(30) Foreign Application Priority Data
Dec. 28, 2021 (CN) 202111625230.3

(51) Int. Cl. G06Q 10/0631

(52) U.S. Cl. CPC G06Q 10/0631

(57) ABSTRACT

The present application relates to the field of network information technology. In response to a problem of designing and manufacturing a product solely based on a user profile in the existing technology, a resource scheduling method and system are provided, so as to achieve a goal that a user satisfies with the products, an enterprise performs efficient production and a resource supplier timely provide resources. The present application ensures efficient production of user personalized products and personalized procurement of the resources by tripartite coordinating the user profile, a product profile and a resource profile; at the same time, forms resource requirements based on a personalized product design; and establishes the resource profile and transmitted it to the resource suppliers, so as to provide resource scheduling references to the resource suppliers for a quick supply.

### CROSS-REFERENCE TO RELATED APPLICATIONS

This application is a continuation of International Application No. PCT/CN2022/140107, filed on Dec. 19, 2022, which claims priority to Chinese patent application No. 202111625230.3, filed to the China National Intellectual Property Administration on Dec. 28, 2021, and entitled “Resource Scheduling Method and System”. The disclosures of the aforementioned applications are incorporated herein by reference in their entireties.

### TECHNICAL FIELD

Embodiments of the present disclosure relate to the field of network information technology and, in particular, to a resource scheduling method and system.

### BACKGROUND

User profile, also known as user information labeling, refers to abstracting a business panorama of a user after collecting and analyzing data of main information, such as social attributes, lifestyle habits, consumption behaviors of consumers by an enterprise, which is a basic way for the enterprise to apply big data technologies.

The user profile provides a sufficient information foundation for the enterprise, which can help the enterprise find broader feedback information such as accurate user groups and user requirements quickly, thereby exploring potential business values. Therefore, an application of the user profile is becoming increasingly widespread.

However, in the existing technologies, the enterprise usually only designs and manufactures products based on the user profile, that is, only the user requirements are considered, without considering a transformation of the user requirement and a matching supply of related resources, which is not conducive to an intelligent transformation of the enterprises in an information age.

A resource scheduling method provided by the present application aims to solve above technical problems of the existing technology.

A main idea about solutions of the present application is: the present application considers from three aspects as the user, the enterprises and resource suppliers, focuses on a goal of accurately capturing the user requirements, accurately customizing the products, and accurately providing services. At the same time, by connecting a resource supply of resources such as raw materials and the like, the resource suppliers can synchronously provide corresponding raw materials to manufacturing enterprises based on the user requirements, or the manufacturing enterprises can customize the products based on user personalization, so as to achieve personalized raw material procurement, thereby achieving reasonable and optimized allocation of resources, achieving a most effective usage of funds, reducing operational pressures on the enterprises, and ultimately achieving the goal that the user satisfies with the products, the enterprises performs efficient production and the resource suppliers timely provide the resources.

Above information disclosed in the Background is only used to enhance an understanding about a background of the present application, and therefore may contain information that has not been formed as the existing technologies acknowledged by ordinary technical personnel in the art.

### SUMMARY

The present application provides a resource scheduling method and system, in order to solve problems existed in the existing technologies.

In a first aspect, the present application provides a resource scheduling method, including:
establishing a user profile, a product profile and a resource profile respectively based on multimodal data;
determining to-be-produced products based on the user profile, and determining resource information corresponding to the to-be-produced products based on the product profile, where the to-be-produced products includes at least two to-be-produced products;
determining production urgency respectively corresponding to the at least two to-be-produced products;
determining a first score corresponding to the production urgency of each to-be-produced product based on descending order of the production urgency of the to-be-produced products;
determining a second score corresponding to the resource information of each to-be-produced product based on descending order of resources required by the to-be-produced products;
determining scheduling order of each to-be-produced product based on a weight, the first score and the second score respectively corresponding to the production urgency and the resource information of each to-be-produced product;
scheduling, according to the scheduling order, the resourced corresponding to the to-be-produced products from a target resource supplier sequentially based on the resource information and the resource profile.

In an implementation, the multimodal data includes at least one of network data, product design data or product after-sales data;
the establishing the user profile based on the multimodal data includes:
inputting at least one of the network data, the product design data or the product after-sales data into a dual features attention-over-attention model to obtain user information, where the user information includes basic user information and product requirement information;
establishing the user profile based on the user information.

In an implementation, the multimodal data includes at least one of network data, product design data, resource supply data, product manufacturing data, product marketing data or product after-sales data;
the establishing the product profile based on the multimodal data includes:
performing a semantic analysis on at least one of the network data, the product design data, the resource supply data, the product manufacturing data, the product marketing data or the product after-sales data to determine attribute information of each product, where the attribute information includes at least one of the following: a product function, a product material, product performance or product appearance;
establishing the product profile corresponding to each product based on the attribute information of each product.

In an implementation, the multimodal data includes at least one of product design data, resource supply data or product manufacturing data;
the establishing the resource profile based on the multimodal data includes:
analyzing at least one of the product design data, the resource supply data or the product manufacturing data to determine resource supply information corresponding to each resource supplier, where the resource supply information includes at least one of the following: resource organization information, resource design information, resource manufacturing information or resource supply capacity information;
establishing the resource profile corresponding to each resource supplier based on the resource supply information of each resource supplier.

In an implementation, the resource profile includes resource supply information corresponding to multiple resource suppliers;
before scheduling, according to the scheduling order, the resources corresponding to the to-be-produced products from the target resource supplier sequentially based on the resource information and the resource profile, the method further includes:
determining a first resource supplier among respective resource suppliers that provides the resource information based on the resource supply information respectively corresponding to the multiple resource suppliers in the resource profile;
determining the target resource supplier based on the first resource supplier.

In an implementation, the first resource supplier includes at least two first resource suppliers;
the determining the target resource supplier based on the first resource supplier includes:
determining the first resource supplier with a highest priority between the at least two first resource suppliers as the target resource supplier based on a preset priority level corresponding to the respective resource suppliers.

In an implementation, the determining scheduling order of each to-be-produced product based on the weight, the first score and the second score respectively corresponding to the production urgency and the resource information of each to-be-produced product includes:
determining target scores of the to-be-produced products based on the weight, the first score and the second score respectively corresponding to the production urgency and the resource information of each to-be-produced product;
sorting the to-be-produced products based on descending order of the target scores to determine the scheduling order of the resource corresponding to each to-be-produced product.

In an implementation, the resource profile includes resource supply information respectively corresponding to multiple resource suppliers, and the method further includes:
determining a resource supply volume of each resource supplier based on the resource supply information corresponding to each resource supplier;
if the resource supply volume of the first resource supplier among the multiple resource suppliers is less than a preset value, sending prompt information to a terminal device corresponding to the first resource supplier, where the prompt information is used to remind the first resource supplier that the resource supply volume is less than the preset value.

In the second aspect, the present application provides a resource scheduling system, including:
a multimodal database, configured to store multimodal data, where the multimodal data includes at least one of network data, product design data, resource supply data, product manufacturing data, product marketing data or product after-sales data;
a profiling module, configured to establish a user profile, a product profile and a resource profile respectively based on the multimodal data;
a resource scheduling module, configured to determine to-be-produced products based on the user profile, and determine resource information corresponding to the to-be-produced products based on the product profile, where the to-be-produced product includes at least two to-be-produced products;
the resource scheduling module is further configured to:
determine production urgency respectively corresponding to the at least two to-be-produced products;
determine a first score corresponding to the production urgency of each to-be-produced product based on descending order of the production urgency of the to-be-produced products;
determine a second score corresponding to the resource information of each to-be-produced product based on descending order of resources required by the to-be-produced products;
determine scheduling order of each to-be-produced product based on a weight, the first score and the second score respectively corresponding to the production urgency and the resource information of to-be-produced product;
schedule, according to the scheduling order, the resources corresponding to the to-be-produced products from a target resource supplier sequentially based on the resource information and the resource profile.

The resource scheduling method and system provided by the present application can ensure efficient production of user personalized products and personalized procurement of the resources by tripartite coordinating the user profile, the product profile and the resource profile; at the same time, can form resource requirements based on a personalized product design; and can establish the resource profile and transmitted it to the resource suppliers, so as to provide resource scheduling references to the resource suppliers for a quick supply. The present application closely combines the users, the enterprises, and the resource suppliers, and utilizes a multi-agents profiling technology driven by multimodal data to achieve precise allocation of the users, the products, and the resources.

### BRIEF DESCRIPTION OF DRAWINGS

Accompanying drawings here are incorporated into the specification and form a part of this specification, showing embodiments that comply with the present disclosure, and are used together with the specification to explain principles of the present disclosure.

FIG. 1 is a schematic diagram of a resource scheduling system provided by an embodiment of the present application.

FIG. 2 is a schematic diagram of a resource scheduling method provided by an embodiment of the present application.

Through the above accompanying drawings, clear embodiments of the present disclosure have been shown, and more detailed descriptions will be provided in the following. These accompanying drawings and textual descriptions are not intended to limit a concept scope of the present disclosure in any way, but rather to illustrate the concepts of the present disclosure to those skilled in the art by referring to specific embodiments.

### DESCRIPTION OF EMBODIMENTS

In order to make purposes, technical solutions, and advantages of embodiments of the present application clearer, the following will provide a clear and complete description of technical solutions in the embodiments of the present application in conjunction with the accompanying drawings of the embodiments of the present application. It is evident that the described embodiments are a part of the embodiments of the present application, not all of them. Based on the embodiments of the present application, all other embodiments obtained by ordinary technical personnel in the art without creative effort would fall within a protection scope of the present application.

Terms used in the embodiments of the present application are only for the purpose of describing specific embodiments, and are not intended to limit the present application. Singular forms of “one” and “the” used in the embodiments of the present application are also intended to include the majority form, unless a context clearly indicates other meanings.

It should also be noted that the terms “include”, “contain” or any other variations thereof are intended to cover non-exclusive inclusion, so that a product or system that includes a series of elements not only includes those elements, but also includes other elements that are not explicitly listed, or also includes the elements inherent in such product or system. Without further limitations, the elements limited by a statement “include a . . . ” do not exclude an existence of other identical elements in the product or system that includes the elements.

The following is a detailed explanation about the technical solution of the present application and how the technical solution of the present application solves the above technical problems through specific embodiments. The following specific embodiments can be combined with each other, and the same or similar concepts or processes may not be repeated in some embodiments. The following will describe the embodiments of the present application in conjunction with the accompanying drawings.

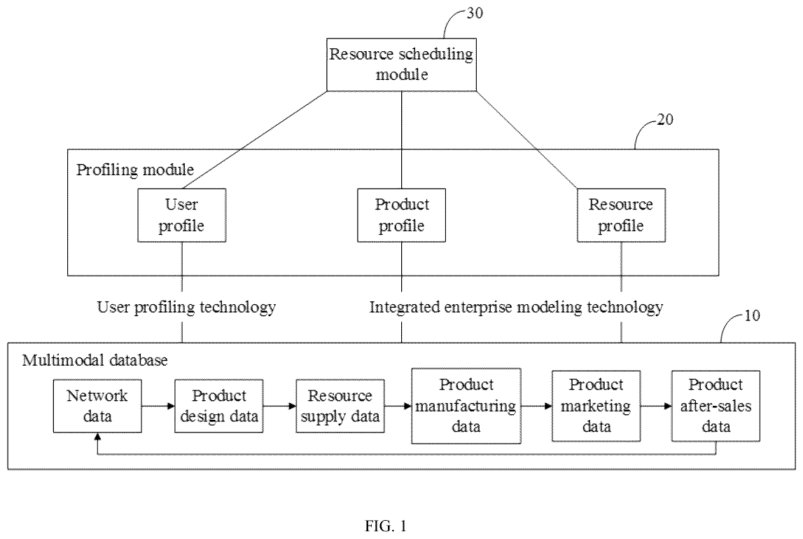

In an implementation, a resource scheduling system is provided, the resource scheduling system is mainly aimed at enterprises. FIG. 1 is a schematic diagram of the resource scheduling system provided by an embodiment of the present application, as shown in FIG. 1, the resource scheduling system includes: a multimodal database 10, a profiling module 20, and a resource scheduling module 30.

Where, the multimodal database 10 is configured to store multimodal data.

Specifically, the present application mainly collects feedback information from three parties like users, products and resource suppliers in all aspects. The collected multimodal data includes at least one of network data, product design data, resource supply data, product manufacturing data, product marketing data or product after-sales data. The above multimodal data covers an entire closed-loop industry chain from product requirements, productions to after-sales feedbacks. Based on the above multimodal data, a user profile can be more accurately depicted, and product and resource profiles can be generated at the same time.

The profiling module 20 is configured to establish a user profile, a product profile and a resource profile respectively based on the multimodal data;
where, the user profile can be achieved based on a user profiling technology, while the product profile and the resource profile can be achieved through an integrated enterprise modeling technology.

The resource scheduling module 30 is configured to determine to-be-produced products based on the user profile, and to determine resource information corresponding to the to-be-produced products based on the product profile, where the to-be-produced product includes at least two to-be-produced products; and
the resource scheduling module 30 is further configured to determine production urgency respectively corresponding to at least two to-be-produced products; determine a first score corresponding to the production urgency of each to-be-produced product based on descending order of the production urgency of the to-be-produced products; determine a second score corresponding to the resource information of each to-be-produced product based on the descending order of resources required by the to-be-produced products; determine scheduling order of each to-be-produced product based on a weight, the first score and the second score respectively corresponding to the production urgency and the resource information of each to-be-produced product; schedule, according to the scheduling order, the resources corresponding to the to-be-produced products from a target resource supplier sequentially based on the resource information and the resource profile.

After establishing the user profile, the product profile and the resource profile, the resource scheduling module links the user profile, the product profile and the resource profile for unified collaboration, that is, a production and procurement system can be comprehensively deployed based on captured profile information.

The resource scheduling system provided by the present application can ensure efficient production of user personalized products and personalized procurement of the resources by tripartite coordinating the user profile, the product profile and the resource profile; at the same time, can form resource requirements based on a personalized product design; and can establish the resource profile and transmitted it to the resource suppliers, so as to provide resource scheduling references to the resource suppliers for a quick supply. The present application closely combines the users, the enterprises, and the resource suppliers, and utilizes a multi-agents profiling technology driven by multimodal data to achieve precise allocation of the users, the products, and the resources.

In an implementation, based on the resource scheduling system shown in FIG. 1 (hereinafter referred to as the system), a resource scheduling method applied to the system is provided.

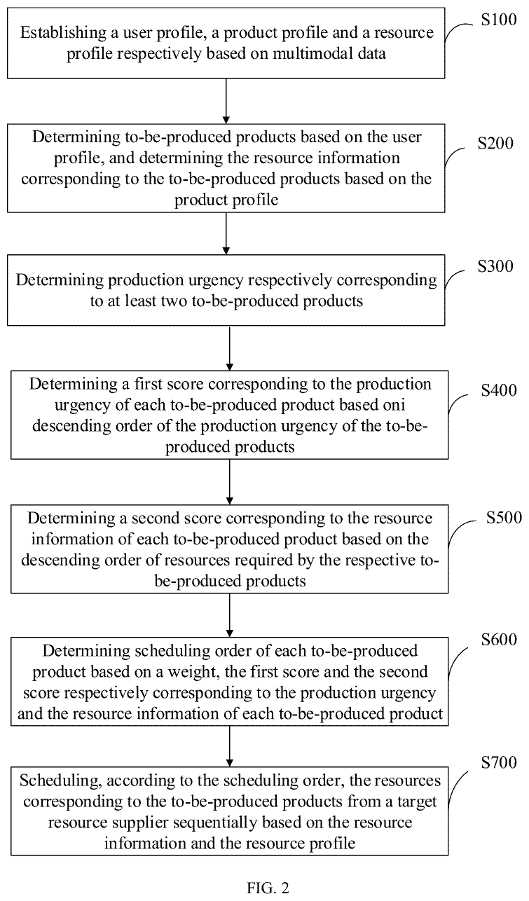

FIG. 2 is a schematic diagram of the resource scheduling method provided by an embodiment of the present application. As shown in FIG. 2, the method mainly includes the following steps.

S100, establishing a user profile, a product profile and a resource profile respectively based on multimodal data.

Specifically, the multimodal data includes at least one of network data, product design data, resource supply data, product manufacturing data, product marketing data or product after-sales data.

Where, the network data specifically refers to data related to a product that can be obtained through network technologies, such as discussion opinions and suggestion information of the products obtained through community forums, post bars and the like.

The product design data mainly stores design solutions based on user requirements and design ideas of a designer, including modification design opinions proposed by users during a production process.

The resource supply data is mainly a current stock situation of various materials required by the design, and a preset value function is innovatively designed. An enterprise can set a normal standard value of various supply indicators in advance, a change would be displayed in real-time as production progresses; when the change is below a preset threshold, flashing an alarm can be used to remind a low stock of a supply status, so as to facilitate timely procurement and processing. At the same time, a usage of the various materials for individual product can be calculated.

The product manufacturing data mainly collects equipment status information for producing products, and calculates equipment usage and working hours for individual product.

The product marketing data mainly collects market sales situations and market distributions of the product, and establishes similar product components and captures enterprise geographical distributions and promotional information of similar products at the same time.

The product after-sales data mainly collects feedback services from distributors, direct stores, and customers through selling the products; at the same time, collects and analyzes information such as subsequent maintenances and repairs for the product, so as to achieve a full lifecycle management of the product.

In this step, the system first establishes the user profile, the product profile and the resource profiles based on the multimodal data.

Where:
(1) the user profile is established based on a perceptual user profiling technology.

In an implementation, the establishing the user profile based on the multimodal data includes: S110, inputting at least one of the network data, the product design data or the product after-sales data into a dual features attention-over-attention model to obtain user information, where the user information includes basic user information and product requirement information; and establishing the user profile based on the user information.

Where, the basic user information includes information such as gender, age, a region, a group and the like, which can be saved as permanent information for the user. The user can make changes by a manually modification, or can choose an automatic updating way to update the basic information regularly.

The product requirement information includes information such as product functional preferences, product appearance preferences, product scenario preferences and the like, which can be dynamically updated based on environments, experiences, emotions and the like of the user. With cognitive computing based profiling technologies, the user requirements can be perceived from the multimodal data.

Specifically, the system can obtain the user information from the multimodal data through community perception, experiential perception and emotional perception. At the same time, based on machine learning technologies, it can not only recommend products (or services) or other elements based on user preferences for past behaviors, but also add and deposit new choices to a user information database timely based on the new choices of the user, to form a real-time profiling mechanism.

In addition, in this embodiment, a dual features attention-over-attention mechanism is established, which combines a machine reading comprehension attention over attention (AOA) with a language bidirectional encoder representation from transformers (BERT) pre-trained model, and proposes a dual features attention-over-attention with BERT (DFAOA-BERT) model. It utilizes the BERT to obtain high-quality word vectors and semantic encodings, calculates AOA values on this basis, and extracts key semantic features. The DFAOA-BERT has designed global and local feature extractors respectively, enabling the model to obtain comprehensive semantic information while effectively reducing negative effects of emotional interferences, and reducing a problem of the emotional interference. Through the DFAOA-BERT model, the user information is extracted from a multimodal database by combining the community perception, experiential perception and emotional perception.
(2) The product profile is established based on an integrated enterprise modeling technology.

In an implementation, the establishing the product profile based on the multimodal data includes: S120, performing a semantic analysis on at least one of the network data, the product design data, the resource supply data, the product manufacturing data, the product marketing data or the product after-sales data to determine attribute information of each product, where the attribute information includes at least one of the following: a product function, a product material, product performance or a product appearance; and establishing the product profiles corresponding to each product based on the attribute information of each product.

Specifically, the system can set product related labels, such as user groups, functional characteristics, performance indicators, material textures, appearance descriptions and the like. Manufacturing enterprises have classified and labeled their existing products according to the labels of a product profiling module. In addition, after the user profile is labeled and classified, which would be entered the product profile to match the existing labels of the product profile, and the matched labels would be extracted. For new labels brought by user profile information, the product profile can automatically create the new labels and form a new product profile with other existing labels that meet the user requirement. The new product profile would fed back a result to an enterprise port through comparing and matching, display product status or calculate production schedule and the like, as well as perform a design and a plan based on the new labels appearing in the user profile.
(3) The resource profile is established based on the integrated enterprise modeling technology.

In an implementation, the establishing the resource profile based on the multimodal data includes: S130, analyzing at least one of the product design data, the resource supply data or the product manufacturing data to determine resource supply information corresponding to each resource supplier, where the resource supply information includes at least one of the following: resource organization information, resource design information, resource manufacturing information or resource supply capacity information; and establishing the resource profile corresponding to each resource supplier based on the resource supply information of each resource supplier.

Specifically, the system would set the labels for organizational resources, design resources, manufacturing resources, supply resources and the like, and the system would mark existing resource suppliers according to the labels. When a resource profiling module and the product profile are linked, it enables to compare a resource storage status based on the product profile; and when a product requirement exceeds a carrying capacity of a resource party, the system can seek new resources based on a product profile requirement, so as to supplement insufficient resources. When the resource profile and the user profile are linked, it enables to select an overlapped resource party based on the user preferences, elevate a priority of the resource party, and determine it as the preferred resource party for the user.

S200, determining to-be-produced products based on the user profile, and determining the resource information corresponding to the to-be-produced products based on the product profile, where the to-be-produced products include at least two to-be-produced products;
after establishing the user profile, the product profile and the resource profile, the system can plan and design products based on real-time information of the user profile, thereby determining the to-be-produced product that meets the user requirements. After completing a product design, the corresponding resource information can be further determined based on the product profile, that is, the resource information such as raw materials and the like required for product production.

S300, determining production urgency respectively corresponding to at least two to-be-produced products.

S400, determining a first score corresponding to the production urgency of each to-be-produced product based on descending order of the production urgency of the to-be-produced products.

S500, determining a second score corresponding to the resource information of each to-be-produced product based on the descending order of resources required by respective to-be-produced products.

S600, determining scheduling order of each to-be-produced product based on a weight, the first score and the second score respectively corresponding to the production urgency and the resource information of each to-be-produced product.

S700, scheduling, according to the scheduling order, the resources corresponding to the to-be-produced products from a target resource supplier sequentially based on the resource information and the resource profile.

After determining the resource information corresponding to the to-be-produced products, the system would schedule the resources from target resource supplier based on the resource information and the resource profiles, enabling the enterprise to have sufficient resources for the product production.

Where, the determining the scheduling order of each to-be-produced product based on the weight, the first score and the second score respectively corresponding to the production urgency and the resource information of each to-be-produced product includes: determining target scores of the to-be-produced products based on the weight, the first score and the second score corresponding to the production urgency and the resource information of each to-be-produced product; and sorting the to-be-produced products in the descending order of the target scores to determine the scheduling order of the resource corresponding to each to-be-produced product.

Specifically, if there are at least two to-be-produced products, when the scheduling order is determined, the scheduling order of the to-be-produced products can be comprehensively determined based on the production urgency of the to-be-produced product and a resource amount required for the to-be-produced product.

For example, the to-be-produced product includes three categories: products A, B, and C:
(1) based on the descending order of the production urgency of the respective to-be-produced products, the first score corresponding to the production urgency of each to-be-produced product is determined as Xa, Xb, and Xc, respectively;
(2) based on the descending order of the resources required by the respective to-be-produced products, the second score corresponding to the resource information of each to-be-produced product is determined as Ya, Yb, and Yc, respectively;
(3) the weight corresponding to the production urgency of each to-be-produced product is set as ma, mb, and mc, respectively; and the weight corresponding to the resource information for each to-be-produced product is set as na, nb, and nc, respectively.

The target score of each to-be-produced product is set as Pa, Pb, and Pc, respectively, then the target score of each to-be-produced product is:

$$Pa = Xa * ma + Ya * na$$

$$Pb = Xb * mb + Yb * nb$$

$$Pc = Xc * mc + Yc * nc$$

Thus, after obtaining the target score of each to-be-produced product, the to-be-produced products are sorted in the descending order of the target score to determine the scheduling order of the resources corresponding to each to-be-produced product.

This embodiment provides the resource scheduling method, which links the user profile, the product profile and the resource profile to form a triangular dynamic loop body, accurately characterizes a correlation between the user requirements, product functions and service characteristics, and achieves a multi-agent collaborative profiling technology among the users, the products and the resources. This method can timely feedback the product requirement frequently changed by the users to the enterprises and resource suppliers, enabling them to plan and design in advance, thereby adapting to the user requirement quickly, predicting market demand changes in advance, and making a product marketing layout. In addition, for the enterprises, products and production resources can be intelligently matched and scheduled based on the user requirement, which has achieved an intelligent integration across enterprise business chains, a rapid response to market and personalized requirements, and optimized resource allocation across the enterprises.

In an implementation, the resource profile includes resource supply information respectively corresponding to multiple resource suppliers;
correspondingly, before scheduling, according to the scheduling order, the resources corresponding to the to-be-produced products from the target resource supplier sequentially based on the resource information and the resource profile, the following is further included: determining a first resource supplier among respective resource suppliers that provides the resource information based on the resource supply information respectively corresponding to the multiple resource suppliers in the resource profile; and determining the target resource supplier based on the first resource supplier.

Specifically, when scheduling the resources, the system can first determine the first resource supplier from respective resource suppliers who can provide the resource information of the to-be-produced products, that is, an optional resource supplier, and then the target resource supplier can be determined from the first resource supplier for resource scheduling.

In an implementation, the first resource supplier includes at least two first resource suppliers, that is, there are at least two resource suppliers who can provide the resource information of the to-be-produced products to the enterprise.

Correspondingly, the determining the target resource supplier based on the first resource supplier includes: determining the first resource supplier with a highest priority between at least two of the first resource suppliers as the target resource supplier.

Specifically, the system can capture resource related data from the multimodal data for classification and integration: similar aggregation can be performed on the same resource party of similar products; while for different resource parties of the same product, priority levels are established based on evaluation to obtain priority levels of different resource suppliers. The enterprise selects the resource party with the highest evaluation preferentially, that is, prefers the resource supplier with the highest priority, which facilitates selections by the enterprise and promote the resource suppliers to enhance their competitiveness.

In an implementation, the resource profile includes resource supply information respectively corresponding to multiple resource suppliers; the method further includes: determining a resource supply volume of each resource supplier based on the resource supply information corresponding to each resource supplier; if the resource supply volume of the first resource supplier among the multiple resource suppliers is less than a preset value, sending prompt information to a terminal device corresponding to the first resource supplier, where the prompt information is used to remind the first resource supplier that the resource supply volume is less than the preset value.

In this embodiment, the system can provide replenishment reminders to the resource suppliers based on a resource supply volume in the resource profile. Specifically, when a value corresponding to the resource supply is lower than a preset value, the system would remind the resource supplier through prompt information, so as to notify the corresponding resource supplier to stock up. At the same time, a reminder mechanism will prioritize resources with high demands and high urgency based on size and urgency of a product requirement volume, which would realize intelligent production scheduling of production tasks for manufacturers, and an intelligentized priority delivery plan for the resource suppliers.

It should be understood that although various steps in a flowchart in the above embodiment are displayed sequentially according to indications of arrows, these steps are not necessarily executed successively in order indicated by the arrows. Unless explicitly stated herein, there is no strict order limit for an execution of these steps, which can be executed in other order. Moreover, at least a portion of the steps in the drawings may include multiple sub-steps or stages, which may not necessarily be completed at the same time, but may be executed at different times, and their execution order may not necessarily be sequential, but may be executed in turn or alternately with at least a portion of other steps or sub-steps or stages.

In an implementation, a computer-readable storage medium is provided, where the computer-readable storage medium stores computer execution instructions, and the computer execution instructions are used to implement the steps of each method embodiment of the present application when executed by a processor.

In an implementation, a computer program product is provided, including a computer program, wherein the computer program implements the steps of each method embodiment of the present application when executed by the processor.

Ordinary technical personnel in this field can understand that, all or part of the processes in the methods of the above embodiments can be completed by instructing the relevant hardware through a computer program. The computer program can be stored in a non-volatile computer readable storage medium, and the computer program can include processes in the above method embodiments during execution. Where, any reference to a memory, storage, a database or other media used in the embodiments provided by the present application can include a non-volatile and/or volatile memory. The non-volatile memory can include a read-only memory (ROM), a programmable ROM (PROM), an electrically programmable ROM (EPROM), an electrically erasable programmable ROM (EEPROM) or a flash memory. The volatile memory can include a random access memory (RAM) or an external cache memory. As an explanation rather than limitation, RAM is available in various forms, such as a static RAM (SRAM), a dynamic RAM (DRAM), a synchronous DRAM (SDRAM), a dual data rate SDRAM (DDRSDRAM), an enhanced SDRAM (ESDRAM), a synchlink (Synchlink) DRAM (SLDRAM), a rambus (Rambus) direct RAM (RDRAM), a direct rambus dynamic RAM (DRDRAM), and rambus dynamic RAM (RDRAM).

After considering the specification and practicing the application disclosed herein, those skilled in the art will easily come up with other implementations of the present disclosure. The present application is intended to cover any modifications, uses, or adaptive variations of the present disclosure, and these modifications, uses, or adaptive variations follow a general principles of the present disclosure and include common knowledge or commonly used technical means in the technical field that are not disclosed in the present disclosure. The specification and the embodiments are only considered exemplary, and a true scope and spirit of the present disclosure are indicated in the following claims.

It should be understood that the present disclosure is not limited to a precise structure already described above and shown in the accompanying drawings, and various modifications and changes can be made without departing from its scope. The scope of the present disclosure is limited only by the accompanying claims.

What is claimed is:

1. A resource scheduling method, comprising:
establishing a user profile, a product profile and a resource profile respectively based on multimodal data;
determining to-be-produced products based on the user profile, and determining resource information corresponding to the to-be-produced products based on the product profile, wherein the to-be-produced products comprise at least two to-be-produced products;
determining production urgency respectively corresponding to the at least two to-be-produced products;
determining a first score corresponding to the production urgency of each to-be-produced product based on descending order of the production urgency of the to-be-produced products;
determining a second score corresponding to the resource information of each to-be-produced product based on descending order of resources required by the to-be-produced products;
determining scheduling order of each to-be-produced product based on a weight, the first score and the second score respectively corresponding to the production urgency and the resource information of each to-be-produced product;
scheduling, according to the scheduling order, the resources corresponding to the to-be-produced products from a target resource supplier sequentially based on the resource information and the resource profile.

2. The method according to claim 1, wherein the multimodal data comprises at least one of network data, product design data, or product after-sales data;
the establishing the user profile based on the multimodal data comprises:
inputting at least one of the network data, the product design data or the product after-sales data into a dual features attention-over-attention model to obtain user information, wherein the user information comprises basic user information and product requirement information;
establishing the user profile based on the user information.

3. The method according to claim 1, wherein the multimodal data comprises at least one of network data, product design data, resource supply data, product manufacturing data, product marketing data or product after-sales data;
the establishing the product profile based on the multimodal data comprises:
performing a semantic analysis on at least one of the network data, the product design data, the resource supply data, the product manufacturing data, the product marketing data or the product after-sales data to determine attribute information of each product, wherein the attribute information comprises at least one of the following: a product function, a product material, product performance or product appearance;
establishing the product profile corresponding to each product based on the attribute information of each product.

4. The method according to claim 1, wherein the multimodal data comprises at least one of product design data, resource supply data or product manufacturing data;
the establishing the resource profile based on the multimodal data comprises:
analyzing at least one of the product design data, the resource supply data or the product manufacturing data to determine resource supply information corresponding to each resource supplier, wherein the resource supply information comprises at least one of the following: resource organization information, resource design information, resource manufacturing information or resource supply capacity information;
establishing the resource profile corresponding to each resource supplier based on the resource supply information of each resource supplier.

5. The method according to claim 1, wherein the resource profile comprises resource supply information corresponding to multiple resource suppliers;
before scheduling, according to the scheduling order, the resources corresponding to the to-be-produced products from the target resource supplier sequentially based on the resource information and the resource profile, the method further comprises:
determining a first resource supplier among respective resource suppliers that provides the resource information based on the resource supply information respectively corresponding to the multiple resource suppliers in the resource profile;
determining the target resource supplier based on the first resource supplier.

6. The method according to claim 5, wherein the first resource supplier comprises at least two first resource suppliers;
the determining the target resource supplier based on the first resource supplier comprises:
determining the first resource supplier with a highest priority between the at least two first resource suppliers as the target resource supplier based on a preset priority level corresponding to the respective resource suppliers.

7. The method according to claim 1, wherein the determining the scheduling order of each to-be-produced product based on the weight, the first score and the second score respectively corresponding to the production urgency and the resource information of each to-be-produced product comprises:
determining target scores of the to-be-produced products based on the weight, the first score and the second score respectively corresponding to the production urgency and the resource information of each to-be-produced product;
sorting the to-be-produced products based on descending order of the target scores to determine the scheduling order of the resource corresponding to each to-be-produced product.

8. The method according to claim 1, wherein the resource profile comprises resource supply information respectively corresponding to multiple resource suppliers, and the method further comprises:
determining a resource supply volume of each resource supplier based on the resource supply information corresponding to each resource supplier;
if the resource supply volume of the first resource supplier among the multiple resource suppliers is less than a preset value, sending prompt information to a terminal device corresponding to the first resource supplier, wherein the prompt information is used to remind the first resource supplier that the resource supply volume is less than the preset value.

9. A resource scheduling system, comprising:
a multimodal database, configured to store multimodal data, wherein the multimodal data comprises at least one of network data, product design data, resource supply data, product manufacturing data, product marketing data or product after-sales data;
a processor;
a communication interface connected with the processor;
a memory connected with the processor and configured to store a computer program;
wherein the processor is configured to read the computer program stored in the memory to be enabled to:
establish a user profile, a product profile and a resource profile respectively based on the multimodal data;
determine to-be-produced products based on the user profile, and determine resource information corresponding to the to-be-produced products based on the product profile, wherein the to-be-produced product comprises at least two to-be-produced products;
the processor is further enabled to:
determine production urgency respectively corresponding to the at least two to-be-produced products;
determine a first score corresponding to the production urgency of each to-be-produced product based on descending order of the production urgency of the to-be-produced products;
determine a second score corresponding to the resource information of each to-be-produced product based on descending order of resources required by the to-be-produced products;
determine scheduling order of each to-be-produced product based on a weight, the first score and the second score respectively corresponding to the production urgency and the resource information of each to-be-produced product;
schedule, according to the scheduling order, the resources corresponding to the to-be-produced products from a target resource supplier sequentially based on the resource information and the resource profile.

10. The system according to claim 9, wherein the processor is further enabled to:
input at least one of the network data, the product design data or the product after-sales data into a dual features attention-over-attention model to obtain user information, wherein the user information comprises basic user information and product requirement information;
establish the user profile based on the user information.

11. The system according to claim 9, wherein the processor is further enabled to:
perform a semantic analysis on at least one of the network data, the product design data, the resource supply data, the product manufacturing data, the product marketing data or the product after-sales data to determine attribute information of each product, wherein the attribute information comprises at least one of the following: a product function, a product material, product performance or product appearance;
establish the product profile corresponding to each product based on the attribute information of each product.

12. The system according to claim 9, wherein the processor is further enabled to:
analyze at least one of the product design data, the resource supply data or the product manufacturing data to determine resource supply information corresponding to each resource supplier, wherein the resource supply information comprises at least one of the following: resource organization information, resource design information, resource manufacturing information or resource supply capacity information;
establish the resource profile corresponding to each resource supplier based on the resource supply information of each resource supplier.

13. The system according to claim 9, wherein the resource profile comprises resource supply information corresponding to multiple resource suppliers;
wherein the processor is further enabled to:
determine a first resource supplier among respective resource suppliers that provides the resource information based on the resource supply information respectively corresponding to the multiple resource suppliers in the resource profile;
determine the target resource supplier based on the first resource supplier.

14. The system according to claim 13, wherein the first resource supplier comprises at least two first resource suppliers;
wherein the processor is further enabled to:
determine the first resource supplier with a highest priority between the at least two first resource suppliers as the target resource supplier based on a preset priority level corresponding to the respective resource suppliers.

15. The system according to claim 9, wherein the processor is further enabled to:
determine target scores of the to-be-produced products based on the weight, the first score and the second score respectively corresponding to the production urgency and the resource information of each to-be-produced product;
sort the to-be-produced products based on descending order of the target scores to determine the scheduling order of the resource corresponding to each to-be-produced product.

16. The system according to claim 9, wherein the resource profile comprises resource supply information respectively corresponding to multiple resource suppliers, and the processor is further enabled to:
determine a resource supply volume of each resource supplier based on the resource supply information corresponding to each resource supplier;
if the resource supply volume of the first resource supplier among the multiple resource suppliers is less than a preset value, send prompt information to a terminal device corresponding to the first resource supplier, wherein the prompt information is used to remind the first resource supplier that the resource supply volume is less than the preset value.

17. A non-transitory computer readable storage medium, wherein the computer readable storage medium stores computer execution instructions, and when a processor executes the computer execution instructions, the processor is enabled to:
establish a user profile, a product profile and a resource profile respectively based on multimodal data;
determine to-be-produced products based on the user profile, and determining resource information corresponding to the to-be-produced products based on the product profile, wherein the to-be-produced products comprise at least two to-be-produced products;
determine production urgency respectively corresponding to the at least two to-be-produced products;
determine a first score corresponding to the production urgency of each to-be-produced product based on descending order of the production urgency of the to-be-produced products;
determine a second score corresponding to the resource information of each to-be-produced product based on descending order of resources required by the to-be-produced products;
determine scheduling order of each to-be-produced product based on a weight, the first score and the second score respectively corresponding to the production urgency and the resource information of each to-be-produced product;
schedule, according to the scheduling order, the resources corresponding to the to-be-produced products from a target resource supplier sequentially based on the resource information and the resource profile.

18. The non-transitory computer readable storage medium according to claim 17, wherein the multimodal data comprises at least one of network data, product design data, or product after-sales data;
wherein the processor is further enabled to:
input at least one of the network data, the product design data or the product after-sales data into a dual features attention-over-attention model to obtain user information, wherein the user information comprises basic user information and product requirement information;
establish the user profile based on the user information.

19. The non-transitory computer readable storage medium according to claim 17, wherein the multimodal data comprises at least one of network data, product design data, resource supply data, product manufacturing data, product marketing data or product after-sales data;
wherein the processor is further enabled to:
perform a semantic analysis on at least one of the network data, the product design data, the resource supply data, the product manufacturing data, the product marketing data or the product after-sales data to determine attribute information of each product, wherein the attribute information comprises at least one of the following: a product function, a product material, product performance or product appearance;
establish the product profile corresponding to each product based on the attribute information of each product.

20. The non-transitory computer readable storage medium according to claim 17, wherein the multimodal data comprises at least one of product design data, resource supply data or product manufacturing data;
wherein the processor is further enabled to:
analyze at least one of the product design data, the resource supply data or the product manufacturing data to determine resource supply information corresponding to each resource supplier, wherein the resource supply information comprises at least one of the following: resource organization information, resource design information, resource manufacturing information or resource supply capacity information;
establish the resource profile corresponding to each resource supplier based on the resource supply information of each resource supplier.
